(19) United States
(12) Patent Application Publication
(10) Pub. No.: US 2019/0369382 A1
(43) Pub. Date: Dec. 5, 2019

(54) MAGNIFYING DISPLAY SCREEN DEVICE

(71) Applicant: E-LEAD ELECTRONIC CO., LTD., CHANGHUA (TW)

(72) Inventor: Stephen CHEN, CHANGHUA (TW)

(21) Appl. No.: 15/995,418

(22) Filed: Jun. 1, 2018

(51) Int. Cl. G02B 25/00; H04M 1/02

(52) U.S. Cl. CPC G02B 25/002; H04M 1/027

(57) ABSTRACT

The present invention relates to a magnifying display screen device, which includes a stand, a display module, a reflective module and a magnifying module, objects could be magnified several times and imaged far longer than several times of the object distance according to the principle of virtual imaging of concave mirrors, and a screen image of a mobile phone, a computer, a video player, a USB flash drive or a SD memory card can be magnified by a connection with the mobile phone, the computer the video player, the USB flash drive or the SD memory card, to thereby provide the optimized projection light path, so that users could watch an ideal magnified image to effectively reduce the burden on eyes.

### BACKGROUND OF THE INVENTION

### a) Field of the Invention

The invention relates to a magnifying display screen device and, more particularly, to a magnifying display screen device for providing an optimized projection light path, and a screen image of a mobile phone, a computer or a TV can be magnified by a connection with the mobile phone, the computer or the TV, so that users could watch an ideal magnified image to thereby effectively reduce the burden on eyes.

### b) Description of Prior Art

Medicine has proven that look near for a long time is the main cause of myopia except 5% genetic factors. Let's recall activities in daily life that looking near for a long time. Watching TV may usually be thought of, but distance between users and TV is above two or three meters, it is not really looking near. As for eating or dressing, although it is looking near, it is not for a long time. The main activities that looking near for a long time is reading books and writing, looking at mobile phones, tablets and computers may also be added in recent years. Text is the key of humans entering into civilized life, but it has also changed the habit of humans using eyes. Humans rarely look near before using text, so myopia should be a visual problem with a very low probability for ancient humans, and this also explains why humans with myopia have not been eliminated by evolutionism. After text has been invented, myopia spread in a small number of literate people. With the popularization of education, myopia has become common. In recent years, because almost everyone has a smart phone or a tablet, myopia has become normal gradually.

Ophthalmologists often recommend people to keep a distance of 30 cm while reading or writing, and a distance of 60 cm while using a computer, wherein 30 cm or 60 cm is not strict, but just health for eyes. Actually, it is just limited by the operating distance and the size of text and pictures on screen or on books that could not see clearly if it is too far, so the recommendation exists. If it is not limited by operating distance, for example, a computer is used with a mouse, the screen could be farther than books, texts and pictures could be enlarged. Whether a user reads a book or looks at a computer screen, the longer the visual distance the more eye health benefits.

Shortening time to look at near objects means reducing the amount of time spent on reading and writing, and it may let score regress. Do not let children play smart phone is deprived of their leisure, and there are unrealistic difficulties. The only choice that does not affect grades and leisure is to let the visual distance of reading and writing be longer. However, if the visual distance becomes longer, eye recognition ability may decrease, so it is easy to make eyes tired unless fonts and images are enlarged. Moreover, a longer visual distance may exceed the range of human hands, and the visual distance limit of reading and writing naturally is about 40 cm. To increase the visual distance may have to rely on new technology.

In order to solve the above existing problems, the industry has proposed various technical solutions continuously, related technologies can be referred to cited references TW M555049, CN 203608282U, TW 1518369, CN 203057249U, TW 1563361, TW 298625, TW publication number 201608279, CN 201060318Y, TW M541404, TW M535811, TW M536362, TW M548275, wherein a typical representative is CN 203608282U (called the cited reference as follows) as shown in FIG. 1, the cited reference is a mobile phone screen magnifying projector, which includes a projection mirror 51 and a magnifier 52; a mirror 510 is set on the projection mirror 51, the mirror 510 has a concave curvature, that is provided to project the image content obtained from the mobile phone screen 53 to the magnifier 52, the projection mirror 51 may be combined to with the stand 511 to achieve the purpose of being folded and opened; a mirror 520 is set on the magnifier 52, the mirror 520 has a concave curvature, that is provided to magnify the image content of the mobile phone screen 53 received from the projection mirror 51, the magnifier 52 may be combined with the stand 511 to achieve the purpose of being folded and opened; the projection mirror 51 obtains an image of the mobile phone and reflects it to the magnifier 52, and the magnifier 52 magnifies the image of the mobile phone for users to watch. Although the cited reference may provide to magnify and display image content of mobile phones for users to conveniently watch the screen content, users have to manually adjust the angle and the distance of the projection mirror 51 and the magnifier 52 when using it, such an adjustment operation is troublesome and time-consuming for users, it is inconvenient because the optimized projection light path cannot be obtained immediately for users to watch. Moreover, the cited reference is limited to magnify a mobile phone screen, it does not provide for a computer or a TV screen to magnify, so its range of use is very limited.

### SUMMARY OF THE INVENTION

In view of this, the inventor finally accomplished the magnifying display screen device of the present invention after numerous improvements, namely, the object of the invention is to provide a magnifying display screen device for providing an optimized projection light path, and a screen image of a mobile phone, a computer or a TV can be magnified by a connection with the mobile phone, the computer or the TV, so that users could watch an ideal magnified image to thereby effectively reduce the burden on eyes. And the projection light path has already been optimized, so users need not to adjust the distance and projection angle of the display module, the reflective module and the magnifying module when using it. A user only need to slightly adjust the angle of the shaft according to his/her body size and his/her watching position, he/she can easily obtain the optimized watching angle.

To achieve the object of the present invention, the magnifying display screen device of the present invention includes:

a stand, a shaft is set on it;

a display module, which is pivoted on the shaft, the display module is provided to display an image;

a reflective module, which includes a reflective sheet and a light shield, the reflective sheet is provided to receive the image displayed by the display module and reflect a reflection image, the light shield is fixed on two sides of the display module and a box body is formed;

a magnifying module, which includes a magnifying sheet and a bracket, the magnifying sheet is provided to receive an reflection image of the reflective sheet and display a magnified image of the reflection image, the bracket is fixed to the top of the display module.

The above reflective sheet is a convex mirror, the magnifying sheet is a concave mirror.

The above display module further includes a speaker unit.

The above shaft is fixed on the back side of the display module.

The above shaft is fixed on the bottom of the display module.

The above shaft includes an elastic piece, the elastic piece is used to provide elasticity to fix the angle.

The stand is an L-shaped frame, multiple non-slip pads are set on the bottom of the stand.

The above bracket is fastened on the display module by multiple screws.

The display module further includes a keypad, the keypad is provided to operate the display module.

The above display module further includes an input connector.

The feature of the present invention is to provide a magnifying display screen device for an optimized projection light path, objects could be magnified several times and imaged far longer than several times of the object distance according to the principle of virtual imaging of concave mirrors, and a screen image of a mobile phone, a computer or a TV can be magnified by a connection with the mobile phone, the computer or the TV to thereby provide the optimized projection light path, so that users could watch an ideal magnified image to effectively reduce the burden on eyes. Besides, in the magnifying display screen device of the present invention, since the provided projection light path of the image has already be optimized with fixed distances and fixed angles of the display module, the reflective module and the magnifying module, a user needs not to adjust the distance and the projection angle between the display module, the reflective module and the magnifying module, he/she only needs to slightly adjust the angle of the shaft according to his/her body size and his/her watching position to easily obtain the optimized watching angle. Therefore, it is easy to use and it may effectively solve the drawbacks of the conventional one.

### BRIEF DESCRIPTION OF THE DRAWINGS

FIG. 1 is a schematic diagram of the prior art;

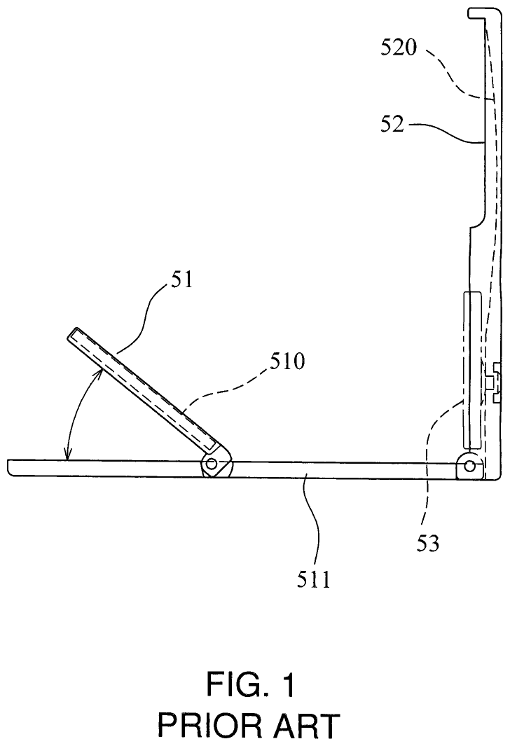

FIG. 2 is a three-dimensional schematic diagram (1) of the present invention;

FIG. 3 is a three-dimensional schematic diagram (2) of the present invention;

FIG. 4 is a three-dimensional exploded diagram of the present invention;

FIG. 5 is a schematic diagram of operation of the present invention;

and

FIG. 6 is a schematic diagram of the projection light path of the embodiment of the present invention.

### DETAILED DESCRIPTION OF THE INVENTION

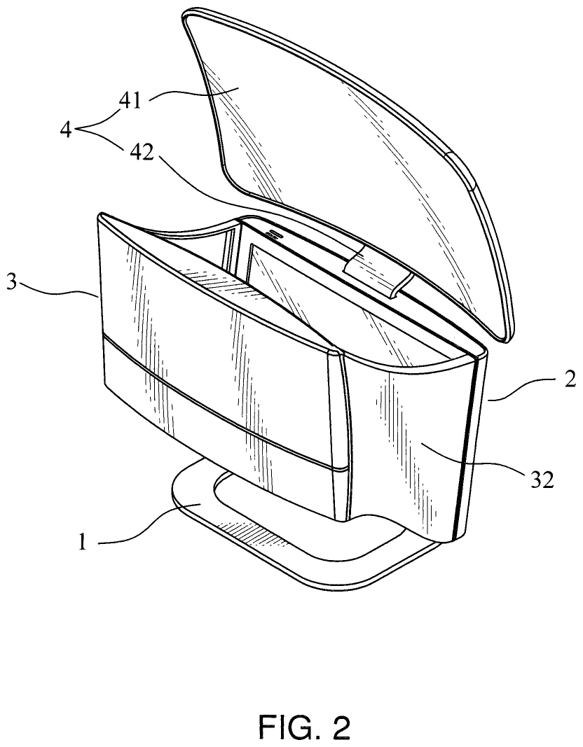

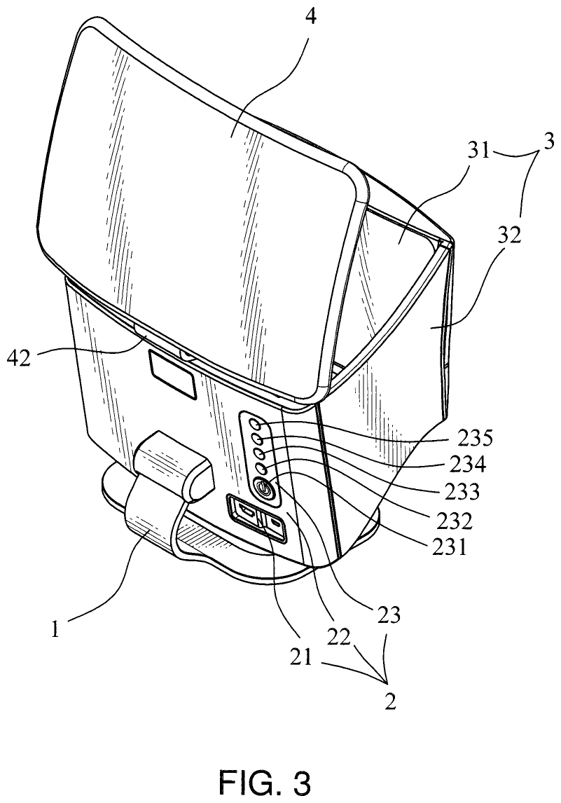

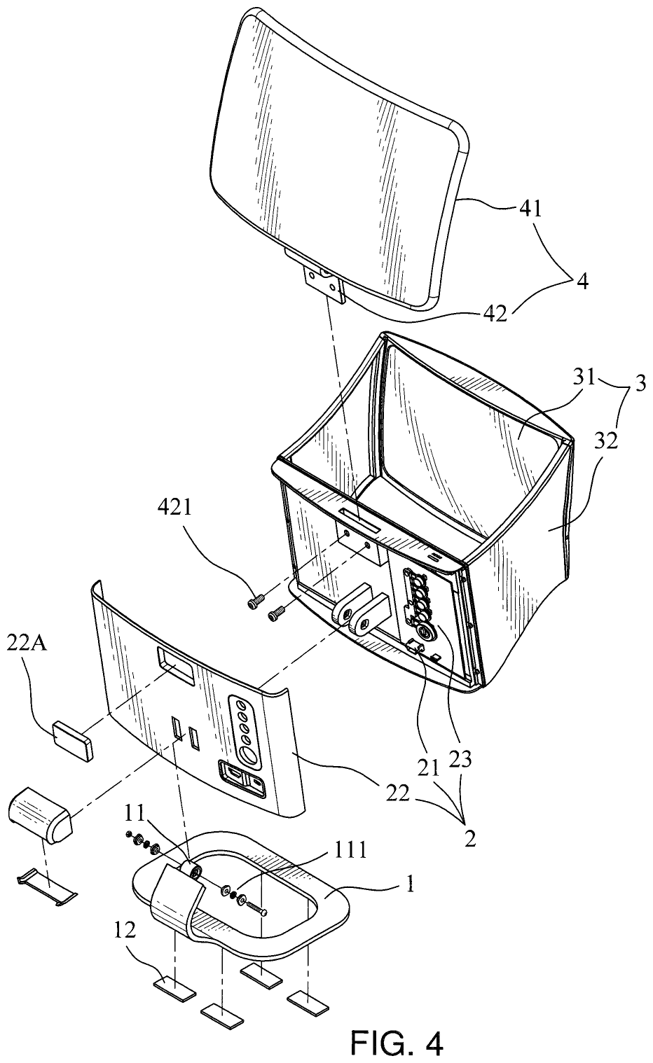

Please refer to FIG. 2 to FIG. 4, the magnifying display screen device A of the present invention includes:

a stand 1, a shaft 11 is set on it;

a display module 2, its one side is pivoted on the shaft 11, the display module 2 is provided to display an image;

a reflective module 3, which includes a reflective sheet 31 and a light shield 32, the reflective sheet 31 is a convex mirror, the reflective sheet 31 is provided to receive the image displayed by the display module 2 and reflect a reflection image, the light shield 32 is fixed on two sides of the display module 2 and a box body is formed;

a magnifying module 4, which includes a magnifying sheet 41 and a bracket 42, the bracket 42 is fixed to the top of the display module 2, the magnifying sheet 41 is a concave mirror, principle of virtual imaging is imaging by using a concave mirror, the imaging formula of a concave mirror is: 1/p+1/q=1/f, wherein f: focal distance, q: object distance, p: image distance. By using a general magnification, virtual images could be enlarged and virtual image distance could also be farther at the same ratio, the magnifying sheet 41 is provided to receive an reflection image of the reflective sheet 31 and display a magnified image of the reflection image.

The above shaft 11 includes an elastic piece 111, the shaft 11 could be rotated at will to adjust and fix its angle by the elasticity provided by the elastic piece 111, the position and the angle of the shaft 11 would be fixed after being adjusted because the elasticity of the elastic piece 111 is pushed and supported it.

The stand 1 is an L-shaped frame, multiple non-slip pads 12 are set on its bottom to prevent the magnifying display screen from slipping.

The display module 2 is a LCD screen, a LED screen, a computer screen or a TV screen.

The above display module 2 further includes an input connector 21, a back cover 22, the input connector 21 is a HDMI slot, a DVI slot, a DisplayPort slot, a D-sub slot, a USB slot, a SD memory card slot, the back cover 22 is provided to cover outside the input connector 21.

The above display module 2 further includes a keypad 23, the keypad 23 is provided to operate the display module 2. The keypad 23 includes a power key 231, a menu key 232, an exit key 233, a cursor up key 234 (shown as sign <) and a cursor down key 235 (shown as sign >). The power key 231 is used to start or close the display module 2; the menu key 232 is pressed to shown a screen display menu; when the display module 2 shows the screen display menu, the exit key 233 is pressed to exit the screen display menu; the cursor up key 234 or the cursor down key 235 is pressed to change the setting of current function.

The above display module 2 further includes a speaker unit (not shown in figure), the speaker unit is provided to inform users voice messages.

The above display module 2, the shaft 11 is pivoted to its one side, its ideal pivot position is the back side of the display module 2 (namely, the shaft 11 is fixed to the back side of the display module 2) or the bottom of the display module 2 (namely, the shaft 11 is fixed to the bottom of the display module 2).

The above bracket 42 is fastened to the display module 2 by using multiple screws 421, a back cover 22A is covered outside of the screws 421.

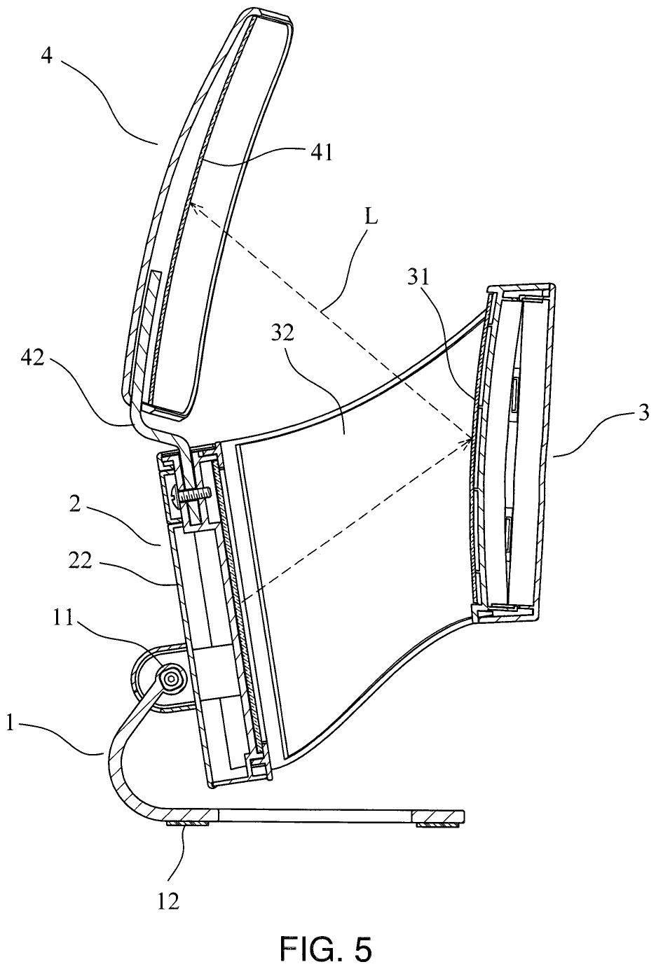

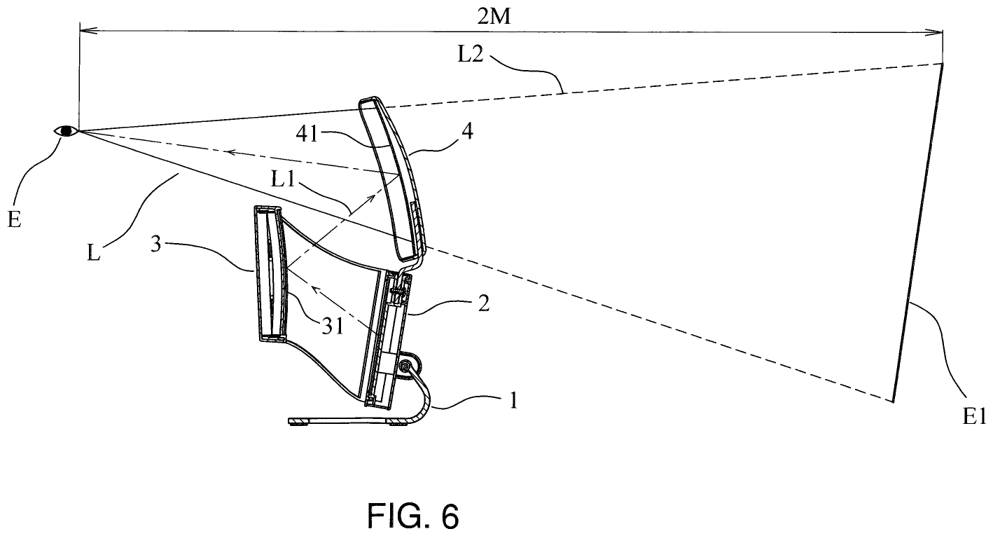

Please refer to FIG. 5, FIG. 6, the projection light path L of the present invention includes a reflective light path L1 and a magnifying light path L2, wherein when a user uses the magnifying display screen device, first, the input connector 21 of the display module 2 is used to connect to a mobile phone (or a computer, a video player, a USB flash drive or a SD memory card) to let the display module 2 displays an image, through the reflective light path L1 of the reflective sheet 31, the eye E of the user could receive the reflection image of the reflective sheet 31 through the magnifying sheet 41, through the magnifying light path L2, the user could watch the magnified image in the remote imaging area E1. As the illustration of the projection light path L of the present invention, the implementation of the present is using the principle of virtual imaging of concave mirrors in Optics to let objects be magnified several times and imaged far longer than several times of the object distance (about two meters). The problem of watching near objects for a long time could be solved by using the optical technology, what the eyes see is magnified with a visual distance of two meters away, so that the users would not have myopia caused by too close to the screen for a long time.

In the present invention, since the projection light path L of the image has already be optimized with fixed distances and fixed angles of the display module 2, the reflective module 3 and the magnifying module 4, a user needs not to adjust the distance and the projection angle between the display module 2, the reflective module 3 and the magnifying module 4, the user only needs to slightly adjust the angle of the shaft 11 according to user's body size and watching position to easily obtain the optimized watching angle, so that the user could watch an ideal magnified image, to thereby reduce the burden on eyes. Simultaneously, since the present invention could be connected to a mobile phone, a computer, a video player, a USB flash drive, a SD memory card, the screen image of the mobile phone, the computer, the video player, the USB flash drive, the SD memory card could be magnified, to thereby effectively improve its range of use.

What is claimed is:

1. A magnifying display screen device, including:
a stand, a shaft is set on it;
a display module, which is pivoted on the shaft, the display module is provided to display an image;
a reflective module, which includes a reflective sheet and a light shield, the reflective sheet is provided to receive the image displayed by the display module and reflect a reflection image, the light shield is fixed on two sides of the display module and a box body is formed;
to a magnifying module, which includes a magnifying sheet and a bracket, the magnifying sheet is provided to receive an reflection image of the reflective sheet and display a magnified image of the reflection image, the bracket is fixed to the top of the display module.

2. The magnifying display screen device as claimed in claim 1, wherein the reflective sheet is a convex mirror, the magnifying sheet is a concave mirror.

3. The magnifying display screen device as claimed in claim 1, wherein the display module further includes a speaker unit.

4. The magnifying display screen device as claimed in claim 1, wherein the shaft is fixed on the back side of the display module.

5. The magnifying display screen device as claimed in claim 1, wherein the shaft includes an elastic piece, the elastic piece is used to provide elasticity to fix the angle.

6. The magnifying display screen device as claimed in claim 1, wherein the stand is an L-shaped frame, multiple non-slip pads are set on the bottom of the stand.

7. The magnifying display screen device as claimed in claim 1, wherein the bracket is fastened to the display module by using multiple screws.

8. The magnifying display screen device as claimed in claim 1, wherein the display module further includes a keypad, the keypad is provided to operate the display module.

9. The magnifying display screen device as claimed in claim 1, wherein the display module further includes an input connector.

10. The magnifying display screen device as claimed in claim 1, wherein the shaft is fixed on the bottom of the display module.
